(19) United States
(12) Patent Application Publication
(10) Pub. No.: US 2021/0294997 A1
(43) Pub. Date: Sep. 23, 2021

(54) REPLACING MACHINE READABLE GRAPHIC CODE PIXELS WITH PREDEFINED COLOR

(71) Applicant: Hewlett-Packard Development Company, L.P., Spring, TX (US)

(72) Inventor: Gideon Amir, Ness Ziona (IL)

(73) Assignee: Hewlett-Packard Development Company, L.P., Spring, TX (US)

(21) Appl. No.: 17/256,393

(22) PCT Filed: Nov. 29, 2018
(86) PCT No.: PCT/US2018/063164

§ 371 Date: Dec. 28, 2020

(51) Int. Cl. G06K 7/10; G06K 19/06; G06K 7/14

(52) U.S. Cl. CPC G06K 7/10861; G06K 7/1417; G06K 19/06037; G06K 19/06103

(57) ABSTRACT

In an example, a method includes receiving, at a processor, a digital version of an image combined with a machine readable graphic code. For a predefined color, a distance in color space between the predefined color and each pixel of the combined image and graphic code may be determined. At least one pixel of the combined image and graphic code may be selectively replaced, wherein the selection is based on the magnitude of the determined distance in color space, such that a first pixel with a smaller determined distance is replaced with a pixel having the predefined color and a second pixel having a larger determined distance is not replaced.

### BACKGROUND

Machine readable graphic codes are representations of data which are readable by a machine via optical means. Examples of machine readable graphic codes are one-dimensional barcodes and two-dimensional barcodes.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1A shows an example machine readable graphic code.

FIG. 1B shows another example machine readable graphic code.

FIG. 2A shows an example image to be combined with an example machine readable graphic code.

FIG. 2B shows a schematic representation of an example combination of the machine readable graphic code shown in FIG. 1B and the image shown in FIG. 2A.

FIG. 3 shows a flowchart of an example method of producing a combined image and graphic code;

FIG. 4 shows a flowchart of another example method of producing a combined image and graphic code;

FIG. 5 shows an example of a machine readable medium in association with a processor.

FIG. 6 shows a diagram of an example print apparatus.

FIG. 7A shows a flowchart of an example method of combining an image with a machine readable graphic code.

FIG. 7B shows a schematic graphical representation of features of the method of FIG. 7A.

### DETAILED DESCRIPTION

Machine readable graphic codes optically represent data for reading by a device, such as a barcode scanner, or a camera in combination with a processor comprising a suitable program for decoding the code. In some examples, a machine readable graphic code may be printed onto a print medium or substrate and affixed to an item. The code may, in some examples, encode information about the item to which it is affixed.

In examples, machine readable graphic codes comprise a plurality of relatively light areas (‘light areas’) and a plurality of relatively dark areas (‘dark areas’). The information encoded by the code is contained in the positioning of the light areas and the dark areas. Such machine readable graphic codes may be referred to as binary machine readable graphic codes. Example types of machine readable codes are one-dimensional, 1D, barcodes, and two-dimensional, 2D, barcodes. 2D barcodes may also be referred to as matrix codes. In a 1D barcode, information may be encoded in the thickness and spacing between parallel lines, which are separated by white lines. A machine readable code may also in some examples contain optical representations of numbers, for example as Arabic numerals. For example, a Universal Product Code, UPC, barcode may comprise optically represented numerals. An example 2D barcode may represent data via a plurality of areas which may be rectangles, dots, hexagons, and/or other geometric patterns. In an example, a 2D barcode, or matrix code, may comprise a plurality of black areas separated by a plurality of white areas, wherein the information encoded by the code is determinable from the shaping and the spacing of the areas. An example of a 2D barcode is a Quick Response, QR, code. Other examples of 2D barcodes are Data Matrix, DM, codes and DotCodes. A machine readable code may comprise a plurality of positioning features, for example a QR code may comprise one positioning feature in each of three corners of a 2D code having four corners, in order to provide an alignment calibration to a machine reading the code. A graphic code may comprise error correction features, such as redundant information-carrying areas of the code, which act to correct errors in reading the code should other areas of the code be unreadable. The provision of error correction features may allow for areas of a generated code to be omitted or modified without rendering the code unreadable.

In some examples, a machine readable graphic code may form part of a mobile payment system. For example, a user may scan a machine readable code such as a QR code with their phone to transfer money to the owner of the QR code.

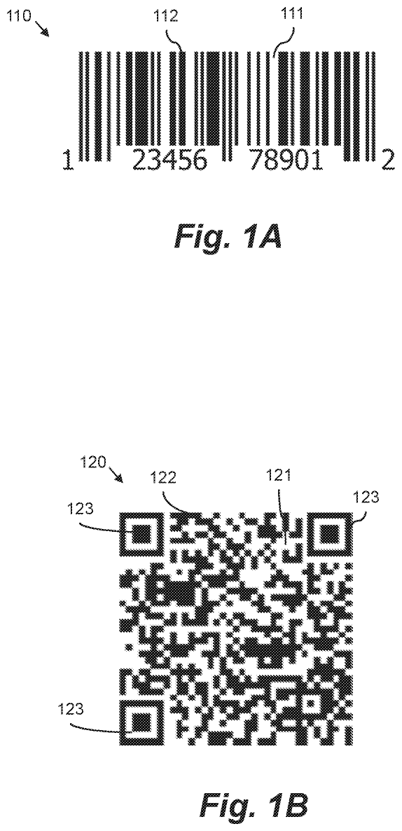

FIG. 1A shows a first example machine readable graphic code 110. The graphic code shown in FIG. 1B is a 1D barcode comprising a plurality of parallel black lines 112 comprising black pixels and a plurality of white spaces 111 comprising white pixels. In addition, human-readable numbers are shown.

FIG. 1B shows a second example machine readable graphic code 120. The graphic code shown in FIG. 1B is a 2D code, namely a QR code, comprising a plurality of white areas 121 comprising light pixels and a plurality of black areas 122 comprising black pixels. The graphic code 120 in this example encodes a hyperlink to https://www8.hp.com/us/en/home.html. The graphic code 120 in this example has been generated with a relatively high error correction level of 30%. The graphic code 120 comprises a plurality of alignment features 123.

As mentioned above, machine readable graphic codes may comprise a plurality of lighter, or white, areas, and a plurality of darker, or black, areas. Since a machine graphic code is displayed optically, it can be visible to a user, for example when affixed to a product, or displayed on a device display. A machine readable graphic code may be combined with an image to produce a combination of the image and the graphic code which displays visual characteristics of an image to a user, while allowing the code to be read by a machine, for example, by using the same image for both the light areas and the dark areas of the machine readable graphic code.

In some examples, an image may comprise any display or color specification for the machine readable graphic code, such as a non-default color, or a non-monochrome color (e.g. the darker areas may be specified to be non-black). In some examples an image may comprise a graphical feature which comprises a color variation, for example including different or variable colors over its surface. In such an example, a machine readable graphic code combined with an image may comprise at least three colors (which may be of the same or different hues). In some examples, an image may comprise, for example text, graphics, a picture, a shape and/or a pattern.

The combination of graphic code and image may also be referred to as a modified image or the combined image in some examples.

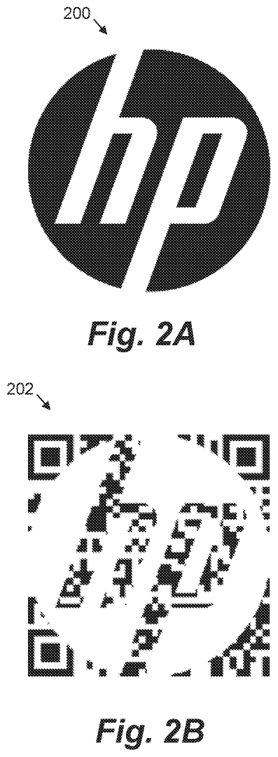

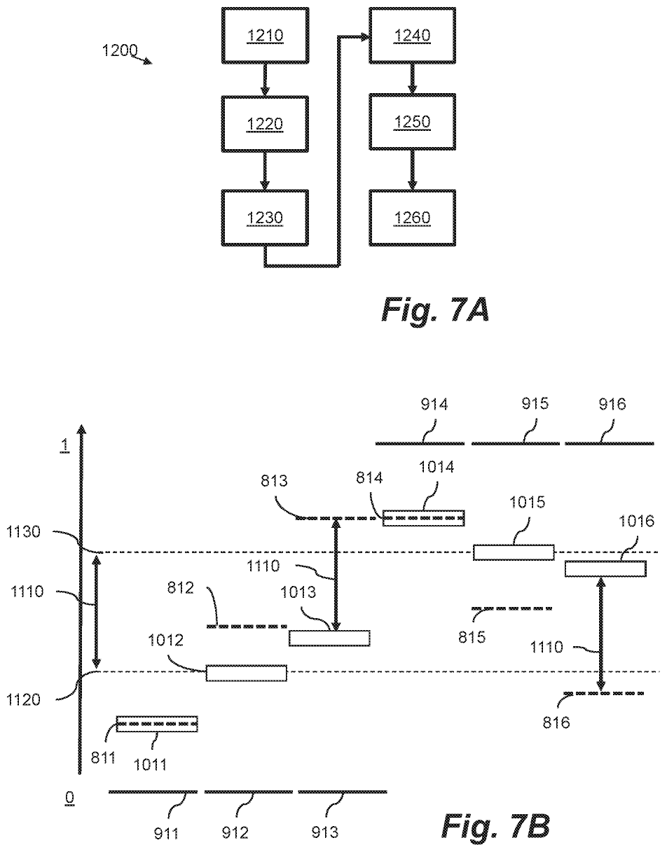

FIG. 2A shows an example of an image 200 and FIG. 2B shows a modified image 202 resulting from a combination of image 200 with the machine readable graphic code 120 of FIG. 1B. The modified image 202 is a schematic representation shown in black and white and thus does not show pixel values which may be present in a combination graphic code and image, and which may reflect non-black and/or variable colors. For example, the combination of the graphic code and the image in modified image 202 does not show the degrees of lightness, and/or other pixel parameters, such as RGB values, or hue and saturation values, which may be present in a combination graphic code and image and, for example, does not show a portion of the areas corresponding to dark areas of the graphic code which may be visible in a combination graphic code and image. In examples, the machine readable graphic code may be generated with an error correction level taking into account readability of the combination of the code and image. For example, the error correction level may be set taking into account the contrast which will be set in the resulting modified combination of code and image. An example method for producing a combination graphic code and image such as that shown in FIG. 2B is discussed in more detail below with reference to FIGS. 7A and 7B. By sacrificing some error correction, empty spaces may be provided, which in turn allow the shape(s) of the image to be clearly delineated. Thus, choosing a graphic code which has been generated with a relatively high error correction level of 30% may allow for a greater amount of error correction sacrifice.

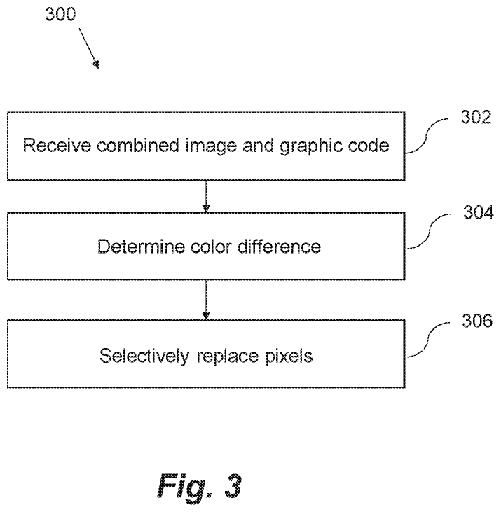

FIG. 3 shows an example method 300, which may be a computer implemented method carried out by at least one processor, and/or may be a method for producing a combined image and machine readable graphic code including pixels having a predefined color. The method comprises, at block 302, receiving, at a processor, a digital version of an image combined with a machine readable graphic code (i.e. a version of the combined image and code represented in data). For example, block 302 may comprise receiving a combined image and graphic code such as the modified image 202 shown in FIG. 2B. In some examples, the digital version of an image combined with a machine readable graphic code may be received from a memory, or remotely over a communications interface. In some examples, the processor may receive the combined image by deriving the digital version of an image combined with a machine readable graphic code, for example using techniques set out in relation to FIGS. 7A and 7B below.

Block 304 comprises, for a predefined color, determining, by a processor, a distance in color space between the predefined color and each pixel of the combined image and graphic code. For each pixel of the combined image and graphic code, the distance in color space represents a color difference between a predefined color and that pixel. The predefined color has predefined color values, or coordinates as defined in a color space, for example L*a*b* color space. In some examples, the predefined color may be a ‘spot’ color, which is a predefined color which is to be printed using a color of ink (e.g. a premixed ink) in a single run, rather than being formed from dots of a number of process colors (such as CMYK) via a halftone process. Using a predefined color such as a spot color in a combined image and graphic code can produce a smooth look which is recognizable in comparison with halftone colors and/or may provide a color which accurately conforms to a particular intended appearance, company branding or the like. Therefore, adding a spot color (or another predefined color) to a picture QR code can make the code more recognizable to a consumer and may, in some examples, make the code harder to copy and thereby preventing fraud.

Determining a distance in color space between the predefined color and each pixel of the combined image and graphic code may comprise calculating a geographical distance in color space. For example, the distance in L*a*b* color space between the predefined color and the color of a particular pixel may be defined as:

ΔE*_{ab}=\sqrt{(L*₂−L*)²+(a*₂−a*₁)²+(b*₂−b*₁)²}

where L*₁, a*₁ and b*₁ are the coordinates in color space that define the predefined color, and L*₂, a*₂ and b*₂ are the coordinates in color space that define the color of the particular pixel. In L*a*b* color space, colors which are perceptually similar to each other are located close to each other in color space. In some examples, the color distance may be defined in an alternative color space such as RGB (Red, Green Blue), HSL (Hue, Saturation Lightness), and an alternative color distance calculation may be used. The determined color differences for each of the pixels of the combined image and graphic code may be stored as an array having the same dimensions as the combined image and graphic code.

Block 306 comprises selectively replacing, by a processor, at least one pixel of the combined image and graphic code, wherein the selection is based on the magnitude of the determined distance in color space, such that a first pixel with a smaller determined distance is replaced with a pixel having the predefined color and a second pixel having a larger determined distance is not replaced. That is, the method comprises setting a threshold distance in color space from the predefined color and pixels that have a color which is closer in color space to the predefined color than the threshold distance are replaced with the predefined color, and pixels which are further away from the predefined color than the threshold distance are not replaced. In some examples, the threshold distance may be predefined. In some examples, the threshold distance may be arrived at using an iterative method, e.g. as set out below.

By selectively replacing pixels in this way, the readability of the graphic code may be maintained as the pixels that are replaced are relatively close to the original color (which may in turn be selected with readability in mind).

In some examples, a coverage parameter may be determined which defines the percentage or number of pixels of the combined image and graphic code to be replaced with the predefined color. In some examples, the threshold may be initially set at zero distance from the predefined color, and increased iteratively until enough pixels have been replaced to satisfy the parameter. Including more of a predefined color in the combined image may result in an image which is closer to, for example, a branding of a company (i.e. more of the combined image may be in a corporate color). However, this may be balanced with maintaining readability: by setting the coverage parameter appropriately, a suitable amount of the predefined color may be introduced to produce an intended visual effect without unduly compromising readability.

In some examples, the coverage parameter may be a minimum coverage parameter, which sets a minimum percentage of pixels to be replaced with the predefined color. The threshold distance may then be increased iteratively in gradual increments, with a check at the end of each iteration to determine whether the minimum coverage parameter has been reached. Once the minimum coverage parameter has been reached then the threshold distance may be fixed.

In some examples, the coverage parameter may be a maximum coverage parameter which defines a maximum percentage of pixels to be replaced.

In some examples, a minimum coverage parameter and a maximum coverage parameter may be set and the threshold distance may be increased iteratively in increments, with a check at the end of each iteration as to whether the number of pixels falling within the threshold distance is between the minimum and the maximum coverage parameters. If the maximum coverage parameter is exceeded, the threshold distance may be decreased iteratively by a smaller increment. In such examples, once the threshold distance is between the minimum and the maximum coverage parameters, the threshold may be fixed.

In some examples, the coverage parameter (for example, a maximum coverage parameter) may be set at a level less than 50%. As the coverage parameter is lowered, the probability that the predefined color will be assigned to both dark and light pixels of the machine readable graphic code reduces, which reduces the chance of the machine readable code becoming unreadable. However, increasing the number of pixels which are replaced in the image provides a higher level of coverage with the predefined color. A coverage parameter, which may be a maximum and/or minimum coverage parameter, of between 10% and 30% has been found to produce codes with a reasonably high probability of being readable while also ensuring enough of the code is shown in the predefined color to make the code noticeably more recognizable. For example, the maximum coverage parameter may be set at 30% and the minimum coverage parameter may be set at 10%.

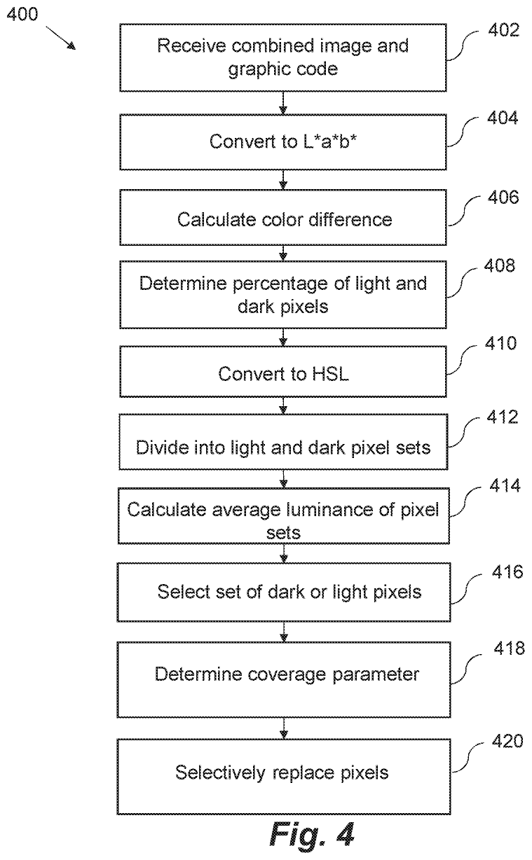

FIG. 4 shows another example method 400 for producing a combined image and machine readable graphic code. The method 400 may be a computer implemented method carried out using at least one processors. Block 402 comprises receiving a combined image and graphic code, as described previously in relation to FIG. 3. In some examples, the combined image and graphic code may be received in a Red, Green, Blue (RGB) format (i.e. as an RGB image), Cyan, Magenta, Yellow, Black (CMYK) format or another color format. In some examples, the combined image and graphic code may be received in a Hue, Saturation, Lightness (HSL) format (i.e. as an HSL image).

The method may comprise, at block 404, if the combined image and graphic code is received in a format other than L*a*b* (for example, RGB), converting, by a processor, the combined image and graphic code to L*a*b* format. In some examples, block 404 also comprises converting the predefined color into a set of coordinates represented in L*a*b* color space. Converting to L*a*b* format enables the color values of the pixels and the predefined color to be represented in a color space where perceptually similar colors are located close to each other in color space.

Block 406 comprises calculating, by a processor, a color difference between each pixel of the combined image and graphic code and a predefined color, as described previously in relation to FIG. 3.

As described above in relation to FIGS. 1A and 1B, the machine readable graphic code may be represented by a combination of black pixels and white pixels. As described below in relation to FIGS. 7A and 7B, when the machine readable graphic code is combined with an image, the lightness of these black and white pixels may be adjusted to be closer to the lightness values of the image, whilst still retaining a difference in lightness between pixels that correspond to black pixels of the graphic code and those that correspond to white pixels. Therefore, in the combined image and graphic code, black pixels of the graphic code may be represented by relatively dark pixels of the combined image and code, and white pixels of the graphic code may be represented by relatively light pixels of the combined image and graphic code. Therefore the combined image and graphic code can be divided into a set of dark pixels (corresponding to black pixels of the graphic code) and a set of light pixels (corresponding to white pixels of the graphic code).

The method comprises, at block 408, determining, by a processor, what percentage of the pixels of the combined image and graphic code represent dark pixels and what percentage represent light pixels. For example, block 408 may comprise acquiring the digital data of the machine readable graphic code (uncombined with the image) and determining the number of black pixels and the number of white pixels. These numbers may be stored as absolute numbers or as percentages of the total number of pixels of the machine readable graphic code. The black pixels and white pixels of the machine readable graphic code may be represented (respectively) as dark pixels and light pixels of the combined image and graphic code.

The method comprises, at block 410 converting, by a processor, the combined image and graphic code to HSL color space. In some examples, block 410 also comprises converting the predefined color into a set of coordinates defined in HSL color space. The method comprises, at block 412, dividing the combined image and graphic code into a set of dark pixels (corresponding to the black pixels of the machine readable code) and a set of light pixels (corresponding to the white pixels of the machine readable code). Block 414 further comprises calculating an average luminance of the set of light pixels and calculating an average luminance of the set of dark pixels. Converting to HSL color space enables a luminance value to be easily determined for each pixel and for the predefined color.

The method may comprise, at block 416, selecting one of the dark set of pixels and the set of light pixels, and not the other of the set of dark pixels and the set of light pixels. In some examples, selecting either the dark set of pixels or the light set of pixels comprises selecting the set of pixels that has an average luminance, or lightness value which is closest to the luminance, or lightness of the predefined color. Selecting either the light set of pixels or the dark set of pixels enables replacement of pixels with the predefined color for one or other of the sets, which reduces the probability of replacing both dark and light pixels of the combined image and graphic code with the predefined color, which could reduce the readability of the graphic code.

The method may comprise, at block 418, determining, by a processor, a coverage parameter, as described above in relation to FIG. 3. In some examples, the coverage parameter may be set at a level which is equal to or lower than the percentage of pixels of the selected set (e.g. either light or dark) in the combined image and graphic code. This enables the predefined color to be swapped for either pixels from the light set of pixels or the dark set of pixels of the combined image and graphic code but not both sets, which may improve the readability of the graphic code. In addition, as the set which is closest to the predefined color in terms of luminance is selected, it may be that more pixels in this set may be replaced for a given threshold color distance than in the un-selected set.

Block 420 of the method comprises selectively replacing pixels of the combined image and graphic code with pixels of the predefined color as described above in relation to FIG. 3. In examples where a set of dark or light pixels has been selected, the replacement may be for either pixels within the dark set or pixels within the light set, which can improve the readability of the combined image and graphic code.

In some examples, the method may comprise replacing a number of pixels of combined image and graphic code with a first predefined color, and replacing a number of pixels of the combined image and graphic code with a second predefined color. For example, after replacement of some of the pixels of the combined image and graphic with pixels of the predefined color, the resultant adjusted combined image and graphic code can be returned to block 302 of method 300 or block 402 of method 400 and the method can be performed again using a different predefined color, to produce a combined image and graphic code including two predefined colors. In some examples, a plurality of predefined colors may be defined as coordinates in color space and predefined colors could be assigned to pixels of the combined image and graphic code by determining, at block 304 or 406, for each pixel, which predefined color is closest in color space to the color of that pixel and determining whether the pixel is within the threshold distance from the closest predefined color, and if so, replacing the pixel with the predefined color.

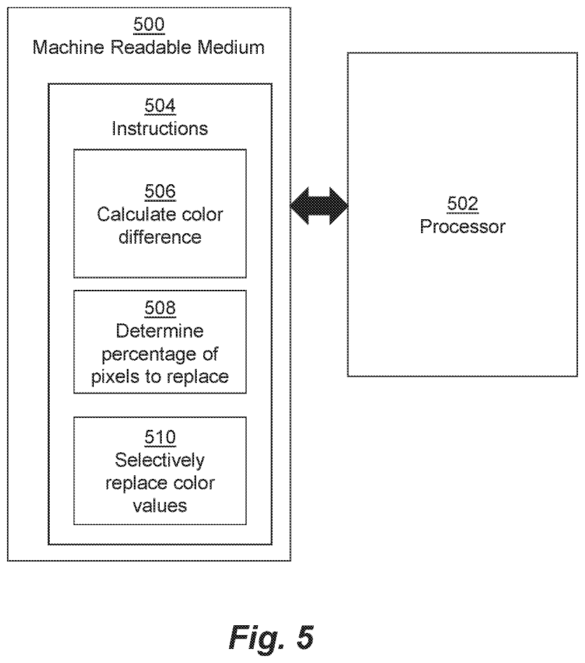

FIG. 5 shows a tangible machine-readable medium 500, comprising a set of instructions 504 which, when executed by a processor 502 cause the processor 502 to perform a method. The tangible machine-readable medium 500 comprises a set of instructions 504 including instructions 506, to cause the processor 502 to, on receipt of an image combined with a machine readable graphic code, and a set of color values defining a predefined color in color space, calculate, for each pixel of the combined image and graphic code, a color difference in the color space between the color of the pixel and the predefined color. The instructions 504 further comprise instructions 508 to cause the processor 502 to determine a percentage of the combined image and graphic code to be replaced with the predefined color. The instructions 504 further comprise instructions 510 to cause the processor 502 to selectively replace color values of pixels of the combined image and graphic code with color values of the predefined color, based on a magnitude of the color difference, in order from pixels having a smaller color difference to pixels having a larger color difference, until the determined percentage is met.

In some examples, the tangible machine-readable medium 500 may comprise a set of instructions 504 which, when executed by a processor 502, cause the processor 502 to perform a method as described with reference to FIG. 3 or FIG. 4, or any of the blocks thereof.

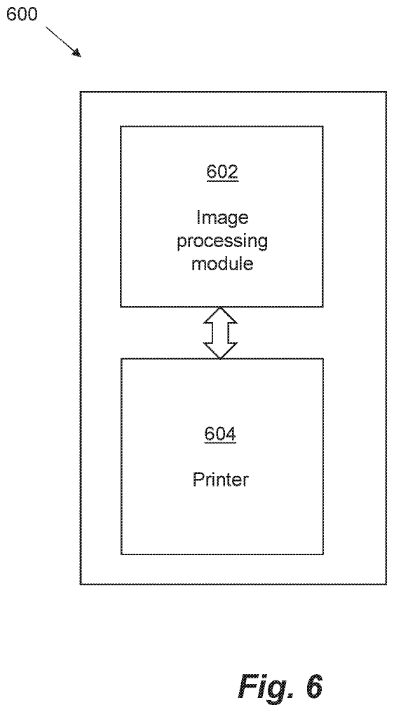

FIG. 6 shows an apparatus 600 which comprises an image processing module 602 and a printer 604, which is in communication with the image processing module 602. The apparatus 600 may be an apparatus for producing a combined image and machine readable graphic code including pixels having a predefined color. The image processing module 602, in use of the apparatus 600, receives an image combined with a machine readable graphic code. The image processing module 602 calculates a distance in color space between predefined color values of a (predefined) color and the color values of each pixel of the combined image and graphic code and replaces a subset of the pixels of the combined image and graphic code, such that pixels which are closer to the predefined color in color space are selected for replacement over pixels which are further away from the predefined color in color space

The printer 604, which comprises apparatus for depositing a print agent such as ink, which may include depositing a print agent of the predefined color (i.e. a spot color), onto a substrate. In use of the apparatus 600, the printer 604 prints the combined image and graphic code.

In some examples, the image processing module 602 may, in use of the apparatus 600, create a first image comprising the subset of pixels having the predefined color and create a second image comprising the pixels of the combined image and graphic code which have not been replaced with the predefined color. The printer 604 may then print the two images such that they are co-located (e.g. overly one another) on a substrate, such as paper, card, plastic, metal, fabric, or any other substrate.

The apparatus 600 may in some examples perform at least one block of the methods described with reference to FIG. 3 or FIG. 4.

### Producing a Combined Image and Machine Readable Graphic Code

An example of how a combined image and machine readable graphic code, such as that shown in FIG. 2B, can be produced is set out below. In other examples, the combined image and graphic code may be produced by another method. For example, where the graphic code comprises error correction features, such as redundant information-carrying areas of the code, such areas could be removed and replaced with an image. In other examples, the combined image and machine readable graphic code may be determined manually by a designer or the like.

In some examples, an image such as image 200 may be combined with a machine readable graphic code, such as QR code 120, by the following example method.

FIG. 7A shows a flow chart representation of an example method 1200 comprising: at block 1210, providing, to a processor, or generating by the processor, an image file. In examples, the image file may represent an image in any suitable file format, such as GIF, PNG, TIFF, JPEG; at any color mode such as RGB or CMYK. The image may be provided to the processor from any suitable machine readable medium. At block 1220, the method 1200 comprises providing, to the processor, or generating by the processor, a machine readable graphic code comprising a plurality of light pixels and a plurality of dark pixels. Light and dark pixels of the graphic code will be referred to hereinafter as white and black graphic code pixels respectively for ease of reference. The machine readable graphic code is a representation which may be read optically by a computer. The machine readable code may be a one-dimensional, 1D, graphic code, such as a 1D barcode, such as a Universal Product Code, UPC, barcode. In other examples, the machine readable code is a two-dimensional, 2D, graphic code, such as a 2D barcode, a Quick Response code, i.e. QR code, or the like. The machine readable graphic code may be provided to the processor in any suitable format, for example any format suitable for encoding an image. In examples the machine readable graphic code is provided in lossless format encoded as, for example, GIF, PNG, TIFF or another suitable format. The abovementioned file can be encoded as a binary image, e.g. black and white, or in a color format using any color mode such as RGB or CMYK.

At block 1230, the method 1200 may comprise determining, using the processor, if the image is the same size as the graphic code, and if the image is not the same size as the graphic code, scaling or cropping the image or the graphic code to make the image the same size as the graphic code. In examples, at least a portion of the image is sized to the machine readable graphic code. For example, the combination of the image and the machine readable graphic code may be produced by changing the number of pixels of the image to match the number of pixels of the graphic code. Changing of the number of pixels of the image may be achieved by, for example, rescaling the image, or cropping the image. At block 1240, the method 1200 comprises associating, by the processor, each pixel of the machine readable graphic code with a corresponding pixel of the image, wherein each image pixel has a lightness. In examples, each pixel of the machine readable graphic code is associated with the image once the image has been resized to the size of the graphic code, if the image is resized. For example, if the graphic code and the image provided to/by the processor are the same size, for example comprising the same number of pixels, then in example methods no resizing may take place. As referred to herein, the term image pixel refers to a pixel of the image after any resizing has been done such that each image pixel is associated with a graphic code pixel.

In examples, the image is converted to a format having a lightness value, or a luminance value. In other examples, the image may be generated by or provided to the processor in a format having a lightness value. An example image format having a lightness value is Hue, Saturation, Lightness, HSL, format. Lightness may also be referred to as luminance, and may be a relative luminance. In examples of HSL used herein, lightness takes a value between and inclusive of 0, corresponding to black, and 1, corresponding to white. Hue may be considered to be the value which defines how an area appears to be similar to one of the perceived colors, e.g. a degree on a color wheel. Saturation can be considered to be the colorfulness of an area relative to its own brightness where saturation is between 0 and 1 inclusive, a saturation of 0 is a shade of gray and a saturation of 1 is full-color. In some examples, the method comprises converting the image from RGB format to HSL format.

At block 1250, the method 1200 comprises determining, by the processor, for each pixel of the image based on a comparison between the lightness of the pixel of the image and a lightness of the corresponding pixel of the graphic code, whether to adjust the lightness of the image pixel based on one of a low threshold lightness value and a high threshold lightness value. In examples, determining for each pixel of the image whether to adjust the lightness of the image pixel comprises: associating one of the lightness threshold values with the dark graphic code pixels and associating the other of the lightness threshold values with the light graphic code pixels, and: for an image pixel associated with a dark graphic code pixel, comparing the lightness of the image pixel to the associated lightness threshold value associated with the dark graphic code pixels, and adjusting the lightness of the image pixel or leaving the lightness of the image pixel unchanged based on a comparison between the lightness of the image pixel and the associated lightness threshold value; and for an image pixel associated with a light graphic code pixel, comparing the lightness of the image pixel to the threshold value associated with the light graphic code pixels, and adjusting the lightness of the image pixel or leaving the lightness of the image pixel unchanged based on a comparison between the lightness of the image pixel and the associated lightness threshold value.

In examples, the method at block 1250 comprises, for each image pixel, determining whether the associated graphic code pixel is white or black (or more generally whether the associated graphic code pixel is a ‘lighter’ or ‘darker’ pixel). In such examples, where the associated graphic code pixel is black, the lightness of the image pixel is compared to the low threshold lightness value. Where the associated graphic code pixel is white, the lightness of the image pixel is compared to the high threshold lightness value.

At block 1260, the method 1200 comprises adjusting, by the processor, the lightness value for each pixel of the image which is to be adjusted to a modified lightness value, such that a combination of the image and the graphic code is produced. In examples, adjusting the lightness of an image pixel, at block 1260, comprises adjusting the lightness of the image pixel to the threshold lightness value associated with the image pixel. In examples, adjusting the lightness of an image pixel comprises adjusting the lightness of the image pixel towards the lightness threshold associated with the image pixel, by the lesser of: the difference between the image pixel lightness and the associated threshold lightness, and a predetermined value, as will be discussed in more detail below. Thus the graphic code may be ‘written into’ the image.

In summary, if an image pixel is to be associated with a black code pixel, but its lightness value is higher than the lower threshold, then it may be determined that the pixel is too light for the code to be read accurately, and the lightness of that pixel may be reduced. If however an image pixel is to be associated with a white code pixel, but its lightness value is lower than higher threshold, then the lightness of that pixel may be increased, so that the pixel can be correctly recognized as a light portion of the code.

In examples, the method comprises for each white pixel of the machine readable graphic code, comparing the lightness value of the image pixel to the high threshold lightness value, and: leaving the lightness value of the image pixel unchanged where the lightness value of the image pixel is greater than or equal to the high threshold lightness value, and increasing the lightness value of the pixel of the image to a modified lightness value where the lightness value of the image pixel is less than the high threshold lightness value. In examples, the modified lightness value for an image pixel associated with a white graphic code pixel is equal to the high threshold lightness value. As such: if the image pixel lightness of the image pixel associated with a white graphic code pixel is less than the high lightness threshold, it is modified to the high lightness threshold; and if the image pixel lightness is greater than or equal to the high lightness threshold the lightness is left unchanged. In other examples, the lightness value of the image pixel is increased by the lesser of: the difference between the image pixel lightness and the high threshold lightness; and a predetermined maximum value. The predetermined maximum value may in some examples be the difference between the high lightness threshold and the low lightness threshold, which is termed herein “delta lightness”. In such examples, the modified lightness value for an image pixel associated with a white graphic code pixel is equal to the image pixel lightness plus the predetermined value, e.g. image pixel lightness plus delta lightness.

In examples, the method at block 1260 comprises, for each image pixel associated with a black pixel of the graphic code, comparing the lightness of the image pixel to the low threshold lightness value, and: leaving the lightness value of the image pixel unchanged where the lightness value of the image pixel is less than or equal to the low threshold lightness value, and decreasing the lightness value of the image pixel of the image to a modified lightness value where the lightness value of the image pixel is greater than the low threshold lightness value. In examples, the modified lightness value for an image pixel associated with a black graphic code pixel is equal to the low threshold lightness value. Similarly to as described for an image pixel associated with a white graphic code pixel, in other examples, when the lightness value of the image pixel is decreased, it is decreased by the lesser of: the difference between the image pixel lightness and the low threshold; and a predetermined maximum value, e.g. delta lightness. As such, in some examples, the modified lightness value for an image pixel associated with a black graphic code pixel is equal to the image pixel lightness minus the predetermined value, e.g. image pixel lightness minus delta lightness.

In examples, modifying the lightness values of pixels as described in the preceding paragraphs provides a version of the image which is modified based on the graphic code, such that the modified version of the image may be successfully read by a machine, to function to impart information encoded in the original graphic code. In example methods, by adjusting the lightness of pixels in the image, light areas and dark areas are produced in the modified image which correspond to the white areas and dark areas of the machine readable code. In examples, the values of the high threshold lightness value and the low threshold lightness value are predetermined to provide a suitable contrast between light areas and dark areas of the combined image and graphic code. The contrast may be set such that the combination of the image and the graphic code is readable as a graphic code by a machine. For example, where lightness takes relative luminance, or lightness, values between 0 and 1 inclusive, the low threshold lightness value may be set at or around 0.3, for example between 0.2 and 0.4, while the high threshold lightness value may be set at or around 0.7, for example between 0.6 and 0.8. In examples, this allows the data encoded in the original graphic code to be read from the combination of image and graphic code. It will be appreciated that, in some examples, the lightness level of one dark area of the code may differ from the lightness level of another dark area of the code (and that the same is true for darker areas).

In examples, a graphic code combined with an image according to example methods may comprise error correction features, as mentioned above. The error correction features may contribute to retaining readability of the information encoded by the graphic code from the modified image. For example, a greater error correction level present in the original graphic code may allow for lesser contrast in the modified image between the light and dark areas, which may allow a user to more easily perceive the image. A graphic code may be generated taking into account the image with which it is to be combined, and an error correction level may be set accordingly to allow the combined image and code to be read correctly. Adjusting the lightness value of pixels of the image based on the associated pixels of the graphic code allows the combined image and graphic code to be produced by making pixels lighter or darker without changing their color. As such, a single parameter, lightness, may be changed to make the adjustment to each pixel.

Example methods may further comprise converting the combination of image and graphic code into a different format, for example RGB or CMYK. As such, in some examples, the original image may be received in an RGB format, converted to HSL for the production of the combined graphic code and image, and the combined graphic code and image then converted to RGB. This may provide for compatibility with other programs and/or devices. In examples, the resulting combined graphic code and image may be displayed by a suitable display device, such as a smart phone screen or a computer monitor. In examples the resulting combined graphic code and image may be printed onto a medium.

FIG. 7B shows a schematic representation of elements of an example method of producing a combination of a machine readable graphic code and an image, to be implemented by a processor. In FIG. 7B, the vertical axis represents the magnitude of pixel lightness, wherein lightness has possible values between and including 0, corresponding to black, and 1, corresponding to white. Pixels of the image, machine readable graphic code, and the combination of the image and the graphic code are represented along the horizontal. Pixels of the machine readable graphic code are represented as solid lines (pixels 911-916), pixels of the image are represented by dashed lines (pixels 811-816), and pixels of the combination of the graphic code and the image are represented as blocks (pixels 1011-1016). Low threshold lightness value 1120 and high threshold lightness value 1130 are shown by dashed lines.

A portion of the graphic code is shown, in this example six pixels 911-916 are represented wherein first, second and third graphic code pixels 911-913 are black, having a lightness of 0, and fourth, fifth and sixth graphic code pixels 914-916 are white, having a lightness of 1. In the example method, the processor associates the first image pixel 811 with the first graphic code pixel 911, and determines that the first graphic code pixel 911 is associated with a black pixel. The lightness of first image pixel 811 is compared to the low threshold value 1120 to determine whether the lightness of first image pixel 811 is below or equal to the low threshold value 1120. In this case, it is determined that the lightness of the first image pixel 811 is below the low threshold value 1120, and, since the first image pixel 811 is associated with black first graphic code pixel 911, the lightness value of the first image pixel 811 is left unchanged. The first graphic code and image combination pixel 1011 therefore has a lightness value equal to that of the first image pixel 811.

Continuing for the second image pixel 812, the second graphic code pixel 912, associated with the second image pixel 812, is black, therefore second image pixel 812 is compared to the low threshold 1120. It is determined that the second image pixel 812 has a lightness greater than the low threshold 1120, therefore a modification to the lightness value of the second image pixel 812 is made to produce the lightness value of the second combination pixel 1012. In this example, the lightness of the second combination pixel 1012 is set at the low threshold 1120, since the associated second graphic code pixel 912 is black and the image pixel lightness is greater than the low threshold 1120.

The third image pixel 813 has a lightness greater than the low threshold 1120 and is associated with a third graphic code pixel 913. Third graphic code pixel 913 is black. Therefore, the lightness of the third image pixel 813 is compared with the low threshold 1120. In the case of third image pixel 813, it is determined that the lightness of the third image pixel 813 is greater than the low threshold 1120. In some examples of the method described herein, in the case of a pixel such as third image pixel 813, i.e. where the lightness of an image pixel associated with a black graphic code pixel is found to be greater than the low threshold, the lightness of the associated combination pixel is set at the low threshold 1120. However, in the example method shown by FIG. 7B, since it is determined that the lightness of the third image pixel 813 is above the low threshold 1120, the resulting third combination pixel 1013 is set at a lightness of the greater of: the low threshold 1120, and the lightness of the third image pixel 813 minus a predetermined value. In this example the predetermined value is delta lightness 1110, i.e. the difference between high lightness threshold 1130 and low lightness threshold 1120. In this case, the lightness of the third image pixel 813 minus delta lightness 1110 is greater than the low threshold 1120, and the lightness of the third image pixel 813 is thus decreased by delta lightness 1110 to give the modified lightness of the third combination pixel 1013. In other words, in this example a maximum difference between the lightness of an image pixel and the lightness of a resulting combination pixel is set at a predetermined maximum value, delta lightness 1110. In other examples, the predetermined maximum value may be set independently of the high threshold 1130 and the low threshold 1120. For example, the predetermined maximum value may be determined to define a maximum contrast in lightness between adjacent pixels. The high threshold value 1130, low threshold value 1120, and the predetermined maximum value, may be chosen such that the resulting combination of graphic code and image has suitable readability by a device which reads the resulting code. Furthermore, setting a predetermined maximum value as in the example method of FIG. 7B may allow the image to be more easily perceptible to a user viewing the resulting combination of image and graphic code.

Fourth image pixel 814 is white and is associated with fourth graphic code pixel 914. Therefore, in the example method, the lightness of fourth image pixel 814 is compared to the high threshold 1130. It is determined that the lightness of fourth image pixel 814 is greater than the high threshold 1130. The lightness of the fourth combination pixel 1014 is therefore set to the lightness of the fourth image pixel 814.

Fifth image pixel 815 is associated with fifth graphic code pixel 915. Fifth graphic code pixel 915 is white. The lightness of fifth image pixel 815 is compared to the high lightness threshold 1130 and is found to be less than high threshold 1130. Furthermore, the difference between lightness of fifth image pixel 815 and the high threshold 1130 is determined to be less than delta lightness 1110. As such, the lightness of the fifth combination pixel 1015 is set at the high threshold 1130.

Sixth image pixel 816 is associated with sixth graphic code pixel 916. Sixth graphic code pixel 916 is white. The lightness of sixth image pixel 816 is compared to the high lightness threshold 1130 and is found to be less than high threshold 1130. The difference between sixth image pixel 816 and the high threshold 1130 is found to be greater than delta lightness 1110. As such, in the example of FIG. 3, the lightness of the sixth combined pixel 1016 is set at a lightness value equal to the lightness of sixth image pixel 816 plus delta lightness 1110. Similarly to the method as mentioned above, in other examples, where the lightness of an image pixel associated with a white graphic code pixel is found to be less than the high threshold, the lightness of the resulting combined pixel is set at the high threshold. For example, in such an example method, the lightness of the sixth combination pixel 1016 may be set at the high threshold 1130.

As described above, in implementing example methods described herein, lightness values of image pixels in HSL format are modified to produce modified pixels. The hue value of the pixel is left unchanged. In some examples, an image pixel with an initially high lightness value may be associated with a black graphic code pixel. In such examples, according to example methods the lightness value of the image pixel is decreased, for example to the low lightness threshold or, in other examples, decreased by a maximum of delta lightness. In some examples, the hue of the pixel may be such that when the lightness of the pixel is decreased, a color of the pixel is exaggerated in terms of its perceptibility by a viewer. For example, a light pixel may appear off-white in the original image but have a red hue. When in this example the lightness is decreased, the pixel may appear as a bright red color, due to the red hue being exaggerated by the decrease in lightness. This effect may result in visible color artefacts in the resulting combined image and graphic code.

In example methods, the above-described color artefacts are reduced by modifying the saturation value of a pixel based on the lightness value of the pixel. For example, for an image pixel associated with a black graphic code pixel, a first predetermined lightness value may be set; if the lightness of the image pixel exceeds the first predetermined lightness value then the saturation value of the combined graphic code and image pixel produced by the method is reduced. For an image pixel associated with a white graphic code pixel, a second predetermined lightness value may be set; if the lightness of the image pixel is less than the second predetermined lightness value, then the saturation value of the combined graphic code and image pixel produced from the image pixel is reduced. In such examples, the saturation value may be reduced to a predetermined value, or may be reduced in a non-linear manner. In an example, the saturation value is reduced by dividing the original saturation value by a predetermined decay value. In examples, the first predetermined lightness value may be at or around 0.6, 0.7, 0.8 or 0.9. The second predetermined lightness value may be at or around, for example, 0.4, 0.3, 0.2, or 0.1. The decay value may be, for example, equal to 1.5, 2, 2.5, or 3.

To describe an example of a method comprising reduction of saturation as described above, in this example, the first predetermined lightness value is 0.6, the second predetermined lightness value is 0.4, and the decay value is 2. In the same example, the low threshold lightness value is 0.3 and the high threshold lightness value is 0.7. In this example, an image pixel having a lightness of 0.7 and a saturation value S is associated with a black graphic code pixel. According to the method, a combined image and graphic code pixel is produced by reducing the lightness of the image pixel from 0.7 to the low threshold 0.3. In this example, the image pixel lightness is greater than the first predetermined lightness of 0.6, and thus, the saturation of the combined image and graphic code pixel is S/(decay value)=S/2. As such, applying this example method, from an image pixel having a lightness 0.7 and saturation S and a black graphic code pixel, a combined image and graphic code pixel is produced having a lightness value 0.3 and a saturation value S/2. In examples, the hue value is left unaltered. In the same example method, an image pixel having a lightness of 0.3 and saturation S is associated with a white graphic code pixel. Since the lightness of the image pixel is less than 0.4, applying the example method to this pixel results in a combined image and graphic code pixel having a lightness value of 0.7 and saturation S/2.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that blocks in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams (for example, the processor 502 and/or the image processing module 602). In particular, a processor or processing apparatus may execute the machine readable instructions. Thus functional modules of the apparatus and devices (for example, the image processing module 602) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage (for example, the machine-readable medium 500) that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims and/or with any other dependent claim(s)

1. A method comprising:
receiving, at a processor, a digital version of an image combined with a machine readable graphic code;
for a predefined color, determining, by a processor, a distance in color space between the predefined color and each pixel of the combined image and graphic code; and
selectively replacing, by a processor, at least one pixel of the combined image and graphic code, wherein the selection is based on the magnitude of the determined distance in color space, such that a first pixel with a smaller determined distance is replaced with a pixel having the predefined color and a second pixel having a larger determined distance is not replaced.

2. A method according to claim 1, further comprising determining, by a processor, a minimum coverage parameter defining a minimum percentage of the pixels of the combined image and graphic code to be replaced with the predefined color.

3. A method according to claim 2 further comprising determining, by a processor, a maximum coverage parameter defining a maximum percentage of the pixels of the combined image and graphic code to be replaced with the predefined color.

4. A method according to claim 3, wherein the maximum coverage parameter is less than 50%.

5. A method according to claim 1 comprising transforming, by a processor, the received digital version of the combined image and graphic code, into L*a*b* color space, and wherein the predefined color is defined within L*a*b* color space.

6. A method according to claim 1 comprising dividing, by a processor, the combined image and graphic code into a set of dark pixels and a set of light pixels.

7. A method according to claim 6, wherein selectively replacing at least one pixel of the combined image and graphic code comprises selectively replacing a plurality of pixels in either the set of dark pixels or the set of light pixels, but not in both sets.

8. A method according to claim 7, further comprising calculating, by a processor, an average luminance value for the set of light pixels and calculating an average luminance value for the set of dark pixels, and replacing pixels from either the dark or light set of pixels based on which set has an average luminance value which is closest to the luminance value of the predefined color.

9. A method according to claim 8 wherein the average luminance value of a set of pixels of the combined image and graphic code and of the predefined color are determined in HSL color space.

10. A tangible machine-readable medium, comprising a set of instructions which when executed by a processor cause the processor to:
on receipt of an image combined with a machine readable graphic code and color values of a predefined color defined in a color space;
calculate, for each pixel of the combined image and graphic code, a color difference in the color space between the color of the pixel and the predefined color;
determine a coverage parameter defining a percentage of the combined image and graphic code to be replaced with the predefined color; and
selectively replace color values of pixels of the combined image and graphic code with color values of the predefined color, based on a magnitude of the color difference, in order from pixels having a smaller color difference to pixels having a larger color difference, until the determined coverage parameter is met.

11. A machine-readable medium according to claim 10, wherein the combined image and graphic code comprises a set of dark pixels and a set of light pixels, and wherein the machine-readable medium further comprises instructions to select either the dark set of pixels or the light set of pixels and wherein selectively replacing color values comprises selectively replacing one or more pixels of the selected set.

12. A machine-readable medium according to claim 11, further comprising instructions to determine what percentage of the pixels of the combined image and graphic code are dark pixels and what percentage are light pixels; and wherein determining the coverage parameter comprises defining a percentage which is lower than or equal to the percentage of pixels of the combined image and graphic code in the selected set.

13. A machine-readable medium according to claim 11 wherein the instructions to select either the dark set of pixels or the light set of pixels comprise instructions to select the set of pixels with an average lightness value closest to a lightness value of the predefined color.

14. An apparatus comprising:
an image processing module to:
receive an image combined with a machine readable graphic code;
for a color having predefined color values, calculate a distance in color space between the predefined color values of the color and the color values of each pixel of the combined image and graphic code;
replace a subset of the of pixels of the combined image and graphic code, such that pixels which are closer to the color having predefined color values in color space are selected for replacement over pixels which are further away from the color having predefined color values in color space; and
a printer to print the combined image and graphic code.

15. An apparatus according to claim 14, further comprising creating a first image comprising the subset of pixels having the predefined color and creating a second image comprising the pixels of the combined image and graphic code which have not been replaced with the color having predefined color values; and printing the two images such that they are co-located on a substrate.
